(19) United States
(12) Patent Application Publication
(10) Pub. No.: US 2024/0402049 A1
(43) Pub. Date: Dec. 5, 2024

(54) RUBBING DETERMINATION DEVICE, RUBBING DETERMINATION METHOD, AND RUBBING DETERMINATION PROGRAM FOR ROTARY MACHINE

(71) Applicant: MITSUBISHI HEAVY INDUSTRIES, LTD., Tokyo (JP)

(72) Inventors: Yuta Imai, Tokyo (JP); Yoshitomo Miyagi, Tokyo (JP); Satoshi Kumagai, Tokyo (JP); Masahiko Yamashita, Tokyo (JP); Yoshinori Tanaka, Tokyo (JP)

(73) Assignee: MITSUBISHI HEAVY INDUSTRIES, LTD., Tokyo (JP)

(21) Appl. No.: 18/690,911

(22) PCT Filed: Feb. 28, 2023
(86) PCT No.: PCT/JP2023/007222

§ 371 Date: Mar. 11, 2024

(30) Foreign Application Priority Data
Mar. 17, 2022 (JP) 2022-042114

(51) Int. Cl. G01M 15/14

(52) U.S. Cl. CPC G01M 15/14

(57) ABSTRACT

This rubbing determination device determines rubbing of a rotary machine which comprises a fixed part and a rotary part. The present device acquires an AE signal detected by means of an AE sensor provided in the rotary machine and acquires a gap amount between the fixed part and the rotary part. A rubbing determination evaluation index is generated on the basis of the AE signal and the gap amount, and rubbing in the rotary machine is determined on the basis of the rubbing determination evaluation index.

### TECHNICAL FIELD

The present disclosure relates to a rubbing determination device, a rubbing determination method, and a rubbing determination program for a rotary machine.

The present application claims priority based on Japanese Patent Application No. 2022-042114 filed in Japan on Mar. 17, 2022, the contents of which are incorporated herein by reference.

### BACKGROUND ART

In a rotary machine such as a steam turbine, a gap between seal portions is reduced due to thermal deformation of an outer casing or an inner casing during an operation, and, thus, rubbing (contact) may occur between a stationary part such as a seal fin and a rotary part such as a rotor. Since the occurrence of such rubbing causes performance degradation due to an increase in shaft vibration of the rotary machine and an increase in the gap, there is a demand for a technique for detecting the rubbing at an early stage.

In addition, as an example of this type of rotary machine, there is a steam turbine connected to a generator in a power generation plant. In such an application, in order to cover a fluctuation in the amount of power generation due to renewable energy in a power system, there is a demand for the steam turbine to operate so as to cope with a load fluctuation. Thus, in recent steam turbines, the gap tends to be reduced for the purpose of coping with such a load fluctuation and improving the performance of the rotary machine, and a probability that rubbing occurs is increasing.

For example, in PTLs 1 and 2, a technique for determining whether or not rubbing occurs and a position thereof based on a result of detecting an acoustic emission (AE) signal generated at the time of rubbing occurrence by an AE sensor is disclosed as such a technique for detecting the rubbing in the rotary machine.

### CITATION LIST

### Patent Literature

[PTL 1] Japanese Unexamined Patent Application Publication No. H08-43193
[PTL 2] Japanese Unexamined Patent Application Publication No. 2021-76533

### SUMMARY OF INVENTION

### Technical Problem

In PTLs 1 and 2 above, although the rubbing determination is performed based on the AE signal detected by the AE sensor as described above, an AE signal may be weakened due to an influence of noise or the like depending on a degree of rubbing and an occurrence position, and it may be difficult to perform accurate rubbing determination.

In addition, as another method for rubbing determination, there is also a technique for measuring or estimating a gap. However, in a case where the gap is directly measured by using a sensor, there is a problem in cost and labor due to new installation of the sensor. In addition, there is also a method of estimating a gap by inputting an operation parameter such as a temperature of a rotary machine into an estimation model corresponding to the rotary machine. Although such a method is advantageous in that it is not necessary to newly install a sensor, in a case where aged deterioration such as wear occurs in the rotary machine, a discrepancy occurs between the rotary machine and the estimation model, and there is a concern that accuracy of rubbing determination will decrease.

At least one embodiment of the present disclosure has been made in view of the above circumstances, and an object thereof is to provide a rubbing determination device, a rubbing determination method, and a rubbing determination program for a rotary machine capable of accurately determining rubbing occurring in a rotary machine.

### Solution to Problem

In order to solve the above problems, a rubbing determination device for a rotary machine according to at least one embodiment of the present disclosure is is a rubbing determination device for a rotary machine, which includes a fixed part and a rotary part. The device includes an AE signal acquisition unit for acquiring an AE signal detected by an AE sensor provided in the rotary machine, a gap amount acquisition unit for acquiring a gap amount between the fixed part and the rotary part, a rubbing determination evaluation index generation unit for generating a rubbing determination evaluation index based on the AE signal and the gap amount, and a rubbing determination unit for determining rubbing in the rotary machine based on the rubbing determination evaluation index.

In order to solve the above problems, a rubbing determination method according to at least one embodiment of the present disclosure is a rubbing determination method for a rotary machine, which includes a fixed part and a rotary part. The method includes a step of acquiring an AE signal detected by an AE sensor provided in the rotary machine, a step of acquiring a gap amount between the fixed part and the rotary part, a step of generating a rubbing determination evaluation index based on the AE signal and the gap amount, and a step of determining rubbing in the rotary machine based on the rubbing determination evaluation index.

In order to solve the above problems, a rotary machine rubbing program according to at least one embodiment of the present disclosure is a rubbing determination program for a rotary machine, which includes a fixed part and a rotary part, causing a computer to execute a step of acquiring an AE signal detected by an AE sensor provided in the rotary machine, a step of acquiring a gap amount between the fixed part and the rotary part, a step of generating a rubbing determination evaluation index based on the AE signal and the gap amount, and a step of determining rubbing in the rotary machine based on the rubbing determination evaluation index.

### Advantageous Effects of Invention

According to at least one embodiment of the present disclosure, it is possible to provide the rubbing determination device, the rubbing determination method, and the rubbing determination program for a rotary machine capable of accurately determining the rubbing occurring in the rotary machine.

### BRIEF DESCRIPTION OF DRAWINGS

FIG. 1 is a cross-sectional structure diagram of a rotary machine according to an embodiment.

FIG. 2 is a block diagram illustrating an internal configuration of a rubbing determination device of FIG. 1.

FIG. 3 is a flowchart schematically illustrating a calculation procedure of an estimated value of a gap amount.

FIG. 4 is a flowchart schematically illustrating a calculation procedure of an estimated value of a gap amount using a machine learning model.

FIG. 5 is a block diagram illustrating an internal configuration of a rubbing determination evaluation index generation unit of FIG. 1.

FIG. 6 is a graph showing a relationship between a difference of an AE signal from a threshold value and a first rubbing occurrence index.

FIG. 7 is a graph showing a relationship between a gap amount and a second rubbing occurrence index.

FIG. 8 is a map illustrating a distribution of rubbing occurrence probabilities for the first rubbing occurrence index and the second rubbing occurrence index.

FIG. 9 is a flowchart illustrating a rubbing determination method according to the embodiment.

FIG. 10 is an example illustrating a temporal change in the rubbing occurrence probability which is an example of a rubbing determination evaluation index.

FIG. 11A is past data used for setting a threshold value for rubbing determination.

FIG. 11B is a diagram illustrating a correlation between a rubbing determination evaluation index and a rubbing determination result based on the past data of FIG. 9A.

FIG. 12 is a flowchart illustrating a rubbing determination method according to another embodiment.

FIG. 13 is a graph showing a temporal change in the rubbing determination evaluation index before and after correction.

### DESCRIPTION OF EMBODIMENTS

Hereinafter, some embodiments of the present disclosure will be described with reference to the accompanying drawings. Dimensions, materials, shapes, relative dispositions, and the like of components described as embodiments or illustrated in the drawings are not intended to limit the scope of the present disclosure, but are merely explanatory examples.

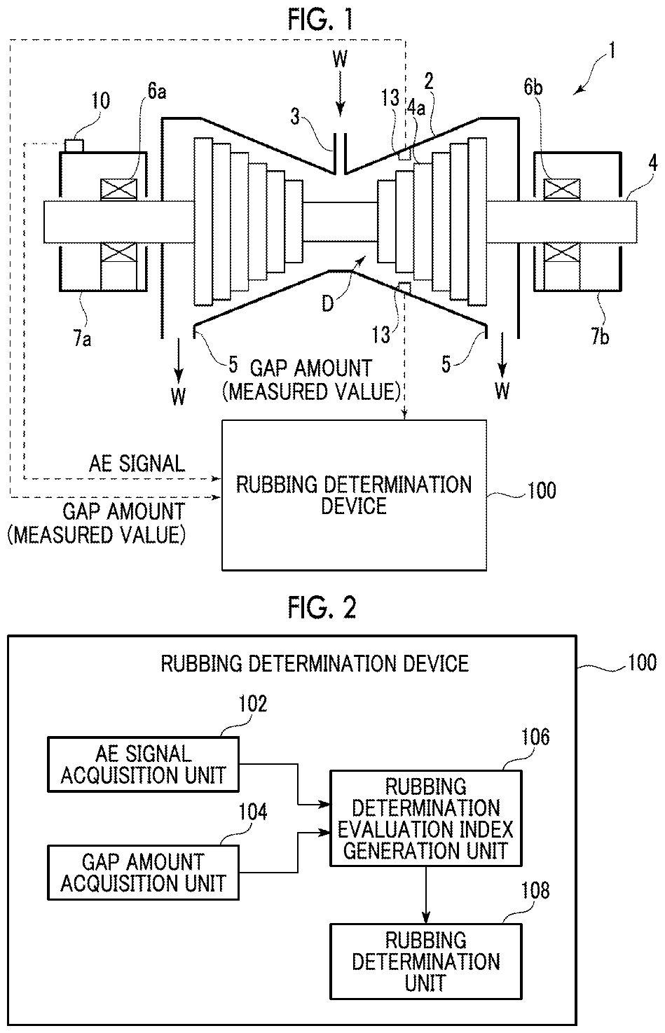

First, a rotary machine 1 to be determined by a rubbing determination device 100 according to at least one embodiment of the present disclosure will be described. FIG. 1 is a cross-sectional structure diagram of the rotary machine 1 according to the embodiment.

The rotary machine 1 includes a stationary part 2 and a rotary part 4 that is rotatable with respect to the stationary part 2. The stationary part 2 is a casing of the rotary machine 1 and is stationary with respect to an outside. The rotary part 4 is rotatably supported with respect to the stationary part 2 via a pair of bearings 6a and 6b.

A gap D is provided between the stationary part 2 and the rotary part 4. The rotary part 4 is driven by a hydraulic fluid W being supplied to the gap D from a supply system 3 provided in the stationary part 2. The hydraulic fluid W that drives the rotary part 4 is discharged to the outside from a discharge part 5 provided in the stationary part 2. During an operation of the rotary machine 1, at least one of the stationary part 2 or the rotary part 4 is deformed due to an influence of heat or the like, and thus, the gap D may be reduced, and rubbing may occur. Whether or not there is such rubbing can be determined based on an AE signal detected by an AE sensor 10 to be described later and on a measured value or an estimated value of the gap D.

The rotary part 4 is, for example, a rotor (rotary shaft) rotatable by power generated by the hydraulic fluid W. The rotary part 4 has a rotor blade 4a for receiving the hydraulic fluid W, and the rotary part 4 is rotationally driven by receiving the hydraulic fluid W in the rotor blade 4a. The rotary machine 1 is, for example, a steam turbine that uses steam as the hydraulic fluid W.

The rotary part 4 is rotatably supported by the pair of bearings 6a and 6b (radial bearings). The bearing 6a is provided on one end side of the rotary part 4, and the bearing 6b is provided on the other end side of the rotary part 4. The bearings 6a and 6b are housed in bearing boxes 7a and 7b, respectively.

The AE sensor 10 is a sensor for detecting the AE signal of the rotary machine 1. An AE wave generated at a rubbing occurrence location propagates, as an elastic wave, through the stationary part 2 and the rotary part 4, and is detected as the AE signal by each AE sensor 10 installed in the rotary machine 1. The AE wave generally has a frequency in a sound wave region of several tens of kHz to several MHz, and is detected as the AE signal by the AE sensor 10. In the present embodiment, the single AE sensor 10 is provided in the bearing 6a (bearing box 7a), and thus, the AE wave from the rubbing occurrence location can be detected.

Although a position where the AE sensor 10 is attached is not limited, for example, the AE sensor 10 may be attached to a bearing portion including the bearings 6a and 6b. In FIG. 1, a case where the AE sensor 10 is attached to the bearing portion including the bearing 6a is illustrated as one configuration example, and more specifically, the AE sensor 10 is attached to the bearing box 7a housing the bearing 6a.

The rubbing determination device 100 is a device for determining rubbing in the rotary machine 1 having the above configuration, and includes, for example, a central processing unit (CPU), a random-access memory (RAM), a read-only memory (ROM), a computer-readable storage medium, and the like. Then, a series of processing for realizing various functions is stored in a storage medium or the like in the form of a program, as an example, and various functions are realized by the CPU reading out this program to the RAM or the like and executing processing for information processing and calculation. A form installed in advance in the ROM or other storage medium, a form provided in a state of being stored in a computer-readable storage medium, or a form of being delivered via wired or wireless communication means, or the like may be applied as the program. The computer-readable storage medium is a magnetic disk, a magneto-optical disk, a CD-ROM, a DVD-ROM, a semiconductor memory, or the like.

FIG. 2 is a block diagram illustrating an internal configuration of the rubbing determination device 100 of FIG. 1. The rubbing determination device 100 includes an AE signal acquisition unit 102, a gap amount acquisition unit 104, a rubbing determination evaluation index generation unit 106, and a rubbing determination unit 108.

The AE signal acquisition unit 102 is configured to acquire the AE signal detected by the above-described AE sensor 10 disposed in the rotary machine 1.

The gap amount acquisition unit 104 is configured to acquire a gap amount De corresponding to a size of the gap D of the rotary machine 1. The gap amount De acquired by the gap amount acquisition unit 104 has several aspects as will be described below, and may be an estimated value or a measured value.

For example, the gap amount De acquired by the gap amount acquisition unit 104 may be an estimated value calculated based on operation data Po of the rotary machine 1. Here, FIG. 3 is a flowchart schematically illustrating a calculation procedure of the estimated value of the gap amount De. In this example, a case where the estimated value of the gap amount De is calculated by using a finite element method is illustrated. The operation data Po includes at least one parameter relating to an operation state of the rotary machine 1, and is input into an estimation model Me corresponding to the rotary machine 1 constructed by the finite element method. In the present embodiment, a metal temperature of the stationary part 2, a rotation speed of the rotary part 4, and an output or an operation time of the rotary machine 1 are input, as the operation data Po, to the estimation model Me, and thus, the gap amount De that is the estimated value is output from the estimation model.

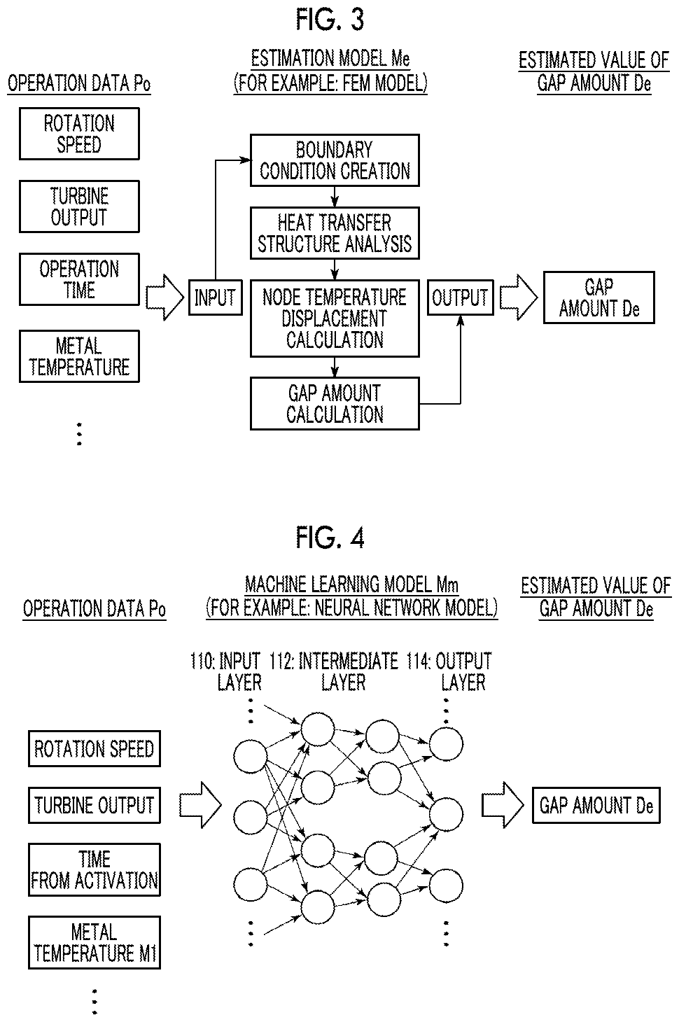

In addition, the gap amount De acquired by the gap amount acquisition unit 104 may be an estimated value calculated by being input to a machine learning model Mm. Here, FIG. 4 is a flowchart schematically illustrating a calculation procedure of the estimated value of the gap amount De using the machine learning model Mm. The machine learning model Mm is, for example, a neural network model including an input layer 110, an intermediate layer 112, and an output layer 114, and a coefficient is optimized by learning using training data (past operation data Po and actually measured values of the gap amount) prepared in advance. The gap amount acquisition unit 104 acquires the estimated value of the gap amount De by inputting the operation data Po of the rotary machine 1 into such a machine learning model Mm.

In this case, the machine learning model Mm used for calculating the estimated value may be modified by feeding back a rubbing determination result in the rubbing determination unit 108. As a result, rubbing determination accuracy of the rotary machine 1 can be improved by updating the machine learning model Mm by learning a latest rubbing determination result.

In addition, the gap amount De acquired by the gap amount acquisition unit 104 may be an actually measured value detected by the gap sensor 13 disposed in the rotary machine 1. As illustrated in FIG. 1, for example, the gap sensor 13 detects an actually measured value of the gap amount De by being disposed at a position on an inner surface of the stationary part 2 facing the rotary part 4.

The rubbing determination evaluation index generation unit 106 is configured to generate a rubbing determination evaluation index based on the AE signal acquired by the AE signal acquisition unit 102 and on the gap amount De acquired by the gap amount acquisition unit 104. The rubbing determination evaluation index is generated in consideration of both the AE signal and the gap amount De in this manner, and thus, accurate rubbing more determination can be performed as compared with a case where only one of the AE signal and the gap amount De is considered.

The rubbing determination evaluation index generation unit 106 may calculate, as the rubbing determination evaluation index, a combination index of the AE signal and the gap amount. The rubbing determination evaluation index is generated by combining the AE signal and the gap amount De in this manner, and thus, accurate rubbing determination can be performed.

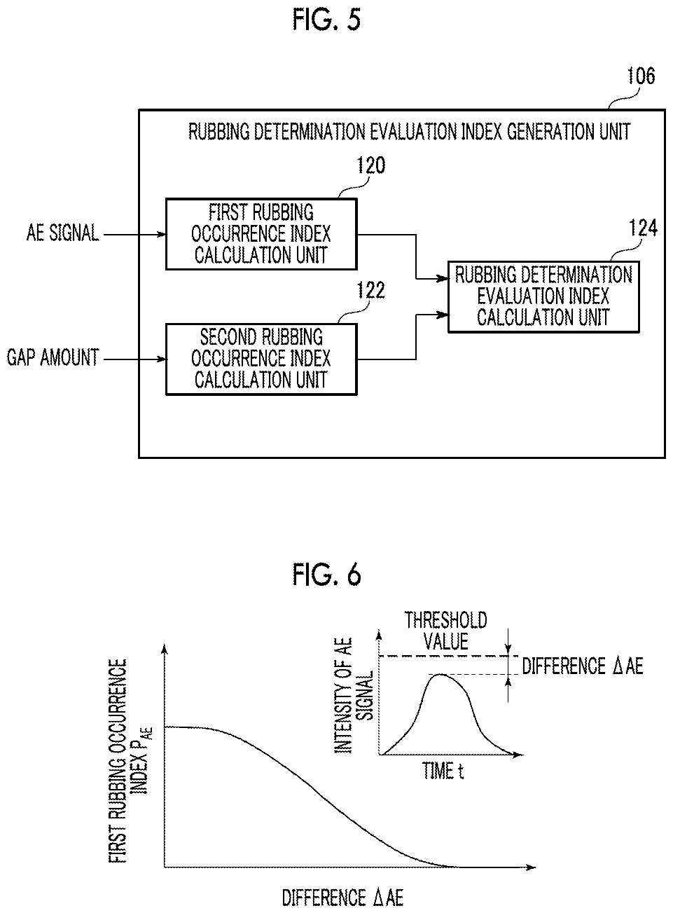

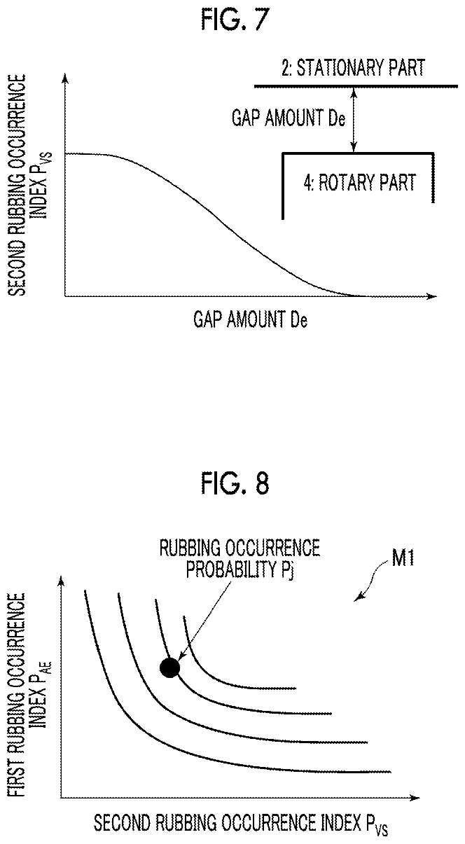

Here, a method for generating the rubbing determination evaluation index in the rubbing determination evaluation index generation unit 106 will be specifically described. FIG. 5 is a block diagram illustrating an internal configuration of the rubbing determination evaluation index generation unit 106 of FIG. 1, and FIG. 6 is a graph showing a relationship between a difference ΔAE from a threshold value of the AE signal and a first rubbing occurrence index P_{AE}. FIG. 7 is a graph showing a relationship between the gap amount De and a second rubbing occurrence index P_{VS}, and FIG. 8 is a map M1 illustrating a distribution of rubbing occurrence probabilities Pj that are examples of the rubbing determination evaluation indexes for the first rubbing occurrence index P_{AE} and the second rubbing occurrence index P_{VS}.

As illustrated in FIG. 5, the rubbing determination evaluation index generation unit 106 according to one aspect includes a first rubbing occurrence index calculation unit 120, a second rubbing occurrence index calculation unit 122, and a rubbing determination evaluation index calculation unit 124. In this aspect, the rubbing determination evaluation index generation unit 106 handles the rubbing occurrence probability Pj as the rubbing determination evaluation index.

The first rubbing occurrence index calculation unit 120 is configured to calculate the first rubbing occurrence index P_{AE} that is the rubbing occurrence probability based on the AE signal. As illustrated in an insertion diagram of FIG. 6, an intensity of the AE signal acquired by the AE signal acquisition unit 102 has a peak waveform that continuously changes with respect to time t. Assuming that a difference between a maximum value (peak value) included in the peak waveform of the AE signal and a preset threshold value is ΔAE, a correlation between the difference ΔAE and the first rubbing occurrence index probability P_{AE} that is the rubbing occurrence probability is prepared in advance as a characteristic graph shown in FIG. 6. The first rubbing occurrence index calculation unit 120 calculates the first rubbing occurrence index P_{AE} that is the rubbing occurrence probability by applying the difference ΔAE corresponding to the AE signal acquired by the AE signal acquisition unit 102 to such a characteristic graph.

The second rubbing occurrence index calculation unit 122 is configured to calculate the second rubbing occurrence index P_{VS} that is the rubbing occurrence probability based on the gap amount De. As illustrated in an insertion diagram of FIG. 7, the gap amount De acquired by the gap amount acquisition unit 104 indicates the size of the gap D between the stationary part 2 and the rotary part 4. A correlation between the gap amount De and the second rubbing occurrence index P_{VS} is prepared in advance as a characteristic graph shown in FIG. 7. The second rubbing occurrence index calculation unit 122 calculates the second rubbing occurrence index that P_{VS} is the rubbing occurrence probability by applying the gap amount De acquired by the gap amount acquisition unit 104 to such a characteristic graph.

The rubbing determination evaluation index calculation unit 124 prepares in advance a map M1 that defines a correlation between the first rubbing occurrence index P_{AE}, the second rubbing occurrence index P_{VS}, and the rubbing occurrence probabilities Pj that are the rubbing determination evaluation indexes, and calculates the rubbing occurrence probabilities Pj corresponding to the first rubbing occurrence index P_{AE} calculated by the first rubbing occurrence index calculation unit 120 and the second rubbing occurrence index P_{VS} calculated by the second rubbing occurrence index calculation unit 122 based on the map M1. As illustrated in FIG. 8, the map M1 defines the distribution of the rubbing occurrence probabilities Pj for the first rubbing occurrence index P_{AE} and the second rubbing occurrence index P_{VS}.

The rubbing determination evaluation index generation unit 106 generates the rubbing occurrence probability Pj calculated in this manner as the rubbing determination evaluation index that is the combination index of the AE signal and the gap amount De.

The rubbing determination unit 108 is configured to determine rubbing in the rotary machine 1 based on the rubbing determination evaluation index generated by the rubbing determination evaluation index generation unit 106. In a case where the rubbing determination unit 108 determines that there is rubbing, an alarm or a screen display may be performed by an output device (not illustrated).

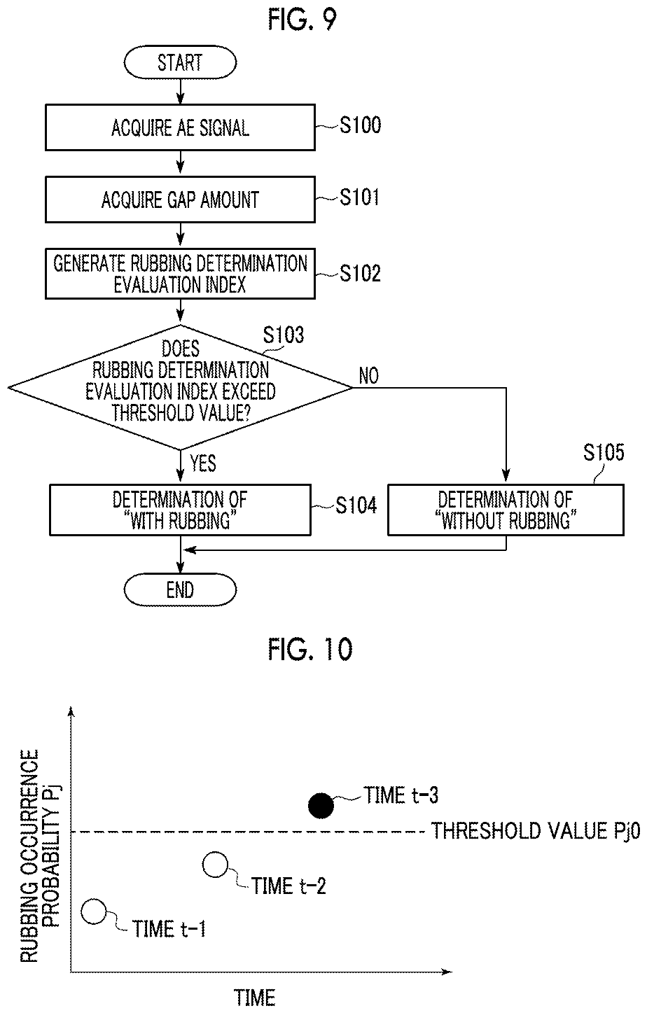

Next, a rubbing determination method performed by the rubbing determination device 100 having the above configuration will be described. FIG. 9 is a flowchart illustrating the rubbing determination method according to the embodiment.

First, the AE signal acquisition unit 102 acquires the AE signal (step S100), and the gap amount acquisition unit 104 acquires the gap amount De (step S101). Subsequently, the rubbing determination evaluation index generation unit 106 generates the rubbing determination evaluation index that is the rubbing occurrence probability Pj based on the AE signal acquired in step S100 and on the gap amount De acquired in step S101 (step S102). The rubbing determination unit 108 determines whether or not the rubbing determination evaluation index that is the rubbing occurrence probability Pj generated in step S102 exceeds a preset threshold value Pj0 (step S103). As a result, in a case where the rubbing occurrence probability Pj that is the rubbing determination evaluation index exceeds the threshold value Pj0 (step S103: YES), a “with rubbing” determination is made (step S104). On the other hand, in a case where the rubbing occurrence probability Pj that is the rubbing determination evaluation index is equal to or less than the threshold value Pj0 (step S103: NO), a “without rubbing” determination is made (step S105).

FIG. 10 is an example illustrating a temporal change in the rubbing occurrence probability Pj that is an example of the rubbing determination evaluation index. FIG. 10 illustrates a behavior in which the rubbing occurrence probability Pj increases with the passage of time. At times t−1 and t−2, the rubbing occurrence probability Pj is equal to or less than the threshold value Pj0 which is a determination reference value. However, at time t−3, the rubbing occurrence probability Pj exceeds the threshold value Pj0, and thus, it is determined that rubbing has occurred.

The rubbing determination evaluation index generation unit 106 according to another aspect may generate the rubbing determination evaluation index including the first rubbing occurrence index calculated by the first rubbing occurrence index calculation unit 120 and the second rubbing occurrence index calculated by the second rubbing occurrence index calculation unit 122, and the rubbing determination unit 108 may determine whether or not there is rubbing based on the rubbing determination evaluation index.

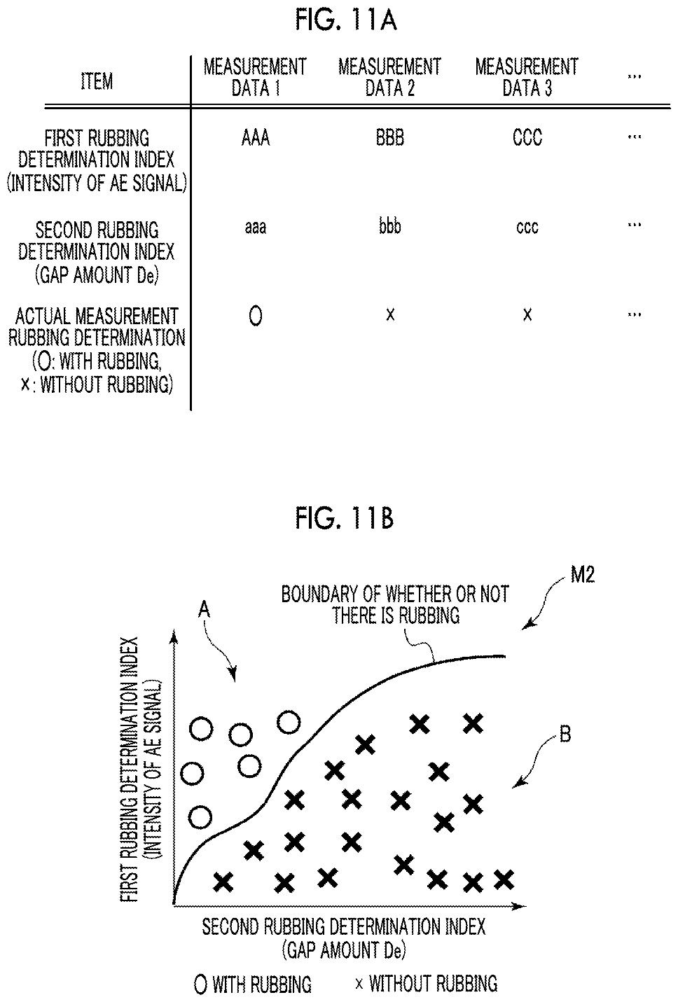

In this aspect, a sufficient number of pieces of past data including the first rubbing occurrence index, the second rubbing occurrence index, and the rubbing determination result are prepared in advance. FIG. 11A is a diagram illustrating the pieces of past data, and FIG. 11B is a map M2 illustrating a correlation between the rubbing determination evaluation index and the rubbing determination result based on the pieces of past data of FIG. 11A. As illustrated in FIG. 11A, the pieces of past data include the AE signal detected by the AE sensor 10, the gap amount De that is the above-described estimated value or actually measured value, and a plurality of pieces of measurement data with which the rubbing determination results based on the actual measurement are associated. The pieces of past data include a sufficiently large amount of such pieces of measurement data, and thus, in a case where the AE signal and the gap amount De are plotted as illustrated in FIG. 11B, a map M2 in which a region A in which the rubbing determination result is “with rubbing” and a region B in which the rubbing determination result is “without rubbing” are specified is created.

The rubbing determination evaluation index generation unit 106 acquires, as the first rubbing occurrence index, the AE signal detected by the AE sensor 10 and acquires, as the second rubbing occurrence index, the gap amount De that is the estimated value or the actually measured value. The rubbing determination unit 108 determines whether or not there is rubbing by applying the AE signal and the gap amount to the map M2 illustrated in FIG. 11B.

In another embodiment, the rubbing determination evaluation index generation unit 106 may generate the rubbing determination evaluation index by correcting the gap amount De acquired by the gap amount acquisition unit 104 based on the combination index. In the present embodiment, the rubbing determination evaluation index generation unit 106 generates the rubbing determination evaluation index by correcting the gap amount De acquired by the gap amount acquisition unit 104 to become zero at a timing when the rubbing occurrence probability Pj that is the above-described combination index exceeds the threshold value Pj0.

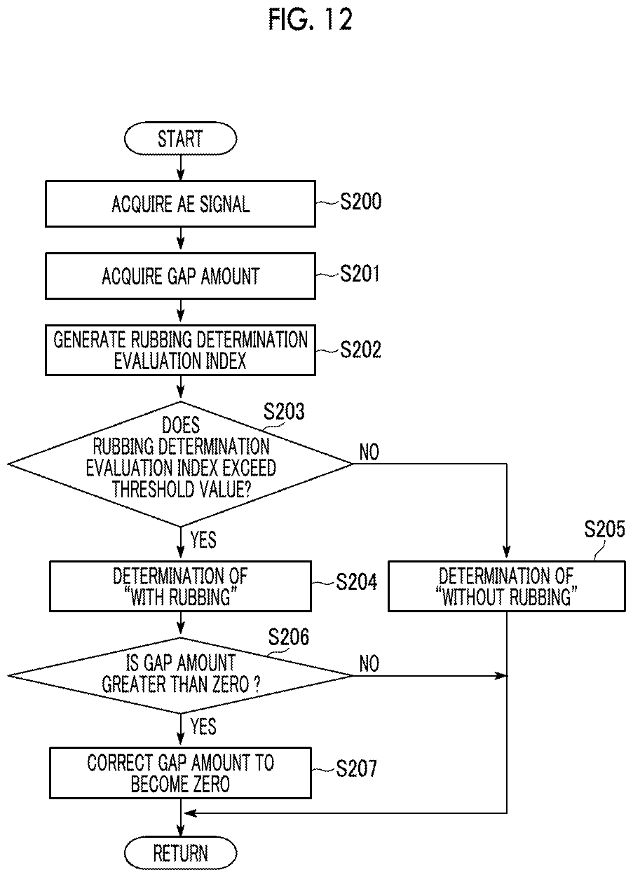

FIG. 12 is a flowchart illustrating a rubbing determination method according to another embodiment. Steps S200 to S205 are similar to steps S100 to S105 in FIG. 10. In a case where the determination of “with rubbing” is made in step S204, it is determined whether or not the gap amount De acquired by the gap amount acquisition unit 104 in step S201 is greater than zero (step S206). As a result, when the gap amount De is greater than zero (step S206: YES), the rubbing determination evaluation index generation unit 106 corrects the rubbing determination evaluation index such that the gap amount De becomes zero (step S207). Thereafter, processing is returned to step S100, and a series of processing is repeatedly performed. In this case, in the subsequent processing, the correction performed in step S207 is applied to the gap amount De acquired in step S201, and the subsequent rubbing determination is performed based on the corrected gap amount De.

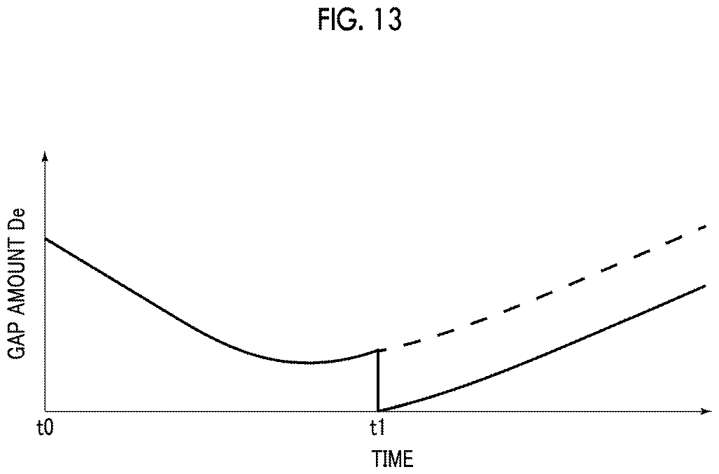

FIG. 13 is a graph showing a temporal change in the rubbing determination evaluation index before and after correction. In FIG. 13, a temporal change in the gap amount De acquired by the gap amount acquisition unit 104 from time t0 is illustrated. In a case where the rubbing occurrence probability Pj exceeds the threshold value Pj0 at time t1, the rubbing determination evaluation index generation unit 106 corrects the rubbing determination evaluation index such that the gap amount De becomes zero. After time t1, the gap amount De corrected at time t1 is output as the rubbing determination evaluation index. A behavior of the gap amount De corrected in this manner is shifted by a certain amount with respect to the gap amount De acquired by the gap amount acquisition unit 104 before time t1 (in FIG. 13, a behavior of the gap amount De in a case where the rubbing determination evaluation index is not corrected after time t1 is indicated by a broken line).

In this way, the gap amount De is corrected to become zero at a timing when the rubbing occurrence probability Pj that is the combination index reaches the threshold value Pj0, and thus, the determination of whether or not there is rubbing is accurately performed. As a result, for example, even in a case where conditions of the rotary machine 1 change due to an aged change, an accurate gap amount De can be obtained. Thus, the gap amount De corrected in this manner is used as the rubbing determination evaluation index, and thus, accurate rubbing determination can be performed.

As described above, according to the above-described embodiment, the rubbing determination is performed based on the rubbing determination evaluation index generated based on the AE signal detected by the AE sensor and on the gap amount that is the measured value or the estimated value. As a result, better determination accuracy can be obtained as compared with the rubbing determination based only on either the AE signal or the gap information.

In addition, it is possible to appropriately replace the components in the embodiments described above with well-known components within the scope which does not depart from the gist of the present disclosure, and the embodiments described above may be combined appropriately.

For example, the contents described in each embodiment are understood as follows.

(1) A rubbing determination device for a rotary machine according to one aspect is a rubbing determination device (100) for a rotary machine, which includes a fixed part and a rotary part. The device includes an AE signal acquisition unit (102) for acquiring an AE signal detected by an AE sensor provided in the rotary machine, a gap amount acquisition unit (104) for acquiring a gap amount between the fixed part and the rotary part, a rubbing determination evaluation index generation unit (106) for generating a rubbing determination evaluation index based on the AE signal and the gap amount, and a rubbing determination unit (108) for determining rubbing in the rotary machine based on the rubbing determination evaluation index.

According to the aspect of the above (1), the rubbing determination is performed based on the rubbing determination evaluation index generated based on the AE signal detected by the AE sensor and on the gap amount that is the measured value or the estimated value. As a result, better determination accuracy can be obtained as compared with the rubbing determination based only on either the AE signal or the gap information.

(2) In another aspect, in the aspect of the above (1), the rubbing determination evaluation index generation unit calculates, as the rubbing determination evaluation index, a combination index of the AE signal and the gap amount.

According to the aspect of the above (2), the rubbing determination evaluation index is generated by combining the AE signal and the gap amount in this manner, and thus, accurate rubbing determination can be performed.

(3) In another aspect, in the aspect of the above (2), the rubbing determination evaluation index generation unit includes a first rubbing occurrence index calculation unit for calculating a first rubbing occurrence probability based on the AE signal, a second rubbing occurrence index calculation unit for calculating a second rubbing occurrence probability based on the gap amount, and a rubbing determination evaluation index calculation unit for calculating, as the combination index, rubbing occurrence probabilities corresponding to the first rubbing occurrence index calculated by the first rubbing occurrence index calculation unit and the second rubbing occurrence index calculated by the second rubbing occurrence index calculation unit by using a map that defines the rubbing occurrence probabilities for the first rubbing occurrence index and the second rubbing occurrence index.

According to the aspect of the above (3), accurate rubbing determination can be performed by using, as the rubbing determination evaluation index, the rubbing occurrence probabilities calculated based on the first rubbing occurrence index corresponding to the AE signal and on the second rubbing occurrence index corresponding to the gap amount.

(4) In another aspect, in the aspect of the above (2) or (3), the rubbing determination evaluation index generation unit generates the rubbing determination evaluation index by correcting the gap amount based on the combination index.

According to the aspect of the above (4), evaluation with an accurate gap amount can be performed even in a case where the conditions for the rotary machine change due to an aged change by correcting the gap amount by using the combination index with which accurate rubbing determination can be performed.

(5) In another aspect, in the aspect of the above (4), the rubbing determination evaluation index generation unit corrects the gap amount to become zero when the combination index reaches a preset threshold value.

According to the aspect of the above (5), the acquired value of the gap amount is corrected to be zero at a timing when the combination index reaches the threshold value, and thus, accurate rubbing occurrence is determined. As a result, for example, even in a case where the conditions for the rotary machine change due to an aged change, it is possible to accurately evaluate the gap amount by correcting the gap amount.

(6) In another aspect, in any one aspect of the above (1) to (5), the gap amount is an estimated value calculated based on operation data of the rotary machine.

According to the aspect of the above (6), the estimated value calculated based on the operation data of the rotary machine is used as the gap amount. Even in a case where the estimated value is used as the gap amount in this manner, the estimated value is used for generating the rubbing determination evaluation index together with the AE signal, and thus, accurate rubbing determination can be performed.

(7) In another aspect, in any one aspect of the above (1) to (5), the gap amount is an estimated value calculated by inputting operation data of the rotary machine into a machine learning model, and the machine learning model is modified by feeding back the rubbing determination evaluation index.

According to the aspect of the above (7), the estimated value is calculated by inputting the operation data of the rotary machine into the machine learning model as the gap amount. Even in a case where the estimated value calculated by using the machine learning model is adopted as the gap amount in this manner, accurate rubbing determination can be performed by using the estimated value for generating the rubbing determination evaluation index together with the AE signal. In addition, the machine learning model is modified based on the rubbing determination evaluation index generated based on the AE signal and the gap amount (estimated value), and thus, the estimation accuracy of the gap amount is improved. As a result, rubbing determination having more excellent accuracy can be performed.

(8) In another aspect, in any one aspect of the above (1) to (5), the gap amount is an actually measured value detected by a gap sensor provided in the rotary machine.

According to the aspect of the above (8), accurate rubbing determination can be performed even in a case where the actually measured value of the sensor is used as the gap amount.

(9) In another aspect, in any one aspect of the above (1) to (8), the AE signal is acquired by the AE sensor provided in a bearing portion that rotatably supports the rotary part with respect to a stationary part.

According to the aspect of the above (9), the AE signal used for generating the rubbing determination evaluation index can be acquired from the AE sensor installed at the bearing portion.

(10) In another aspect, in any one aspect of the above (1) to (9), the rotary machine is a steam turbine.

According to the aspect of the above (10), it is possible to realize the rubbing determination device capable of accurately determining rubbing in the steam turbine.

(11) A rubbing determination method for a rotary machine according to one aspect is a rubbing determination method for a rotary machine, which includes a fixed part and a rotary part. The method includes a step of acquiring an AE signal detected by an AE sensor provided in the rotary machine, a step of acquiring a gap amount between the fixed part and the rotary part, a step of generating a rubbing determination evaluation index based on the AE signal and the gap amount, and a step of determining rubbing in the rotary machine based on the rubbing determination evaluation index.

According to the aspect of the above (11), rubbing determination is performed based on the rubbing determination evaluation index generated based on the AE signal detected by the AE sensor and on the gap amount that is the measured value or the estimated value. As a result, better determination accuracy can be obtained as compared with the rubbing determination based only on either the AE signal or the gap information.

(12) A rubbing determination program for a rotary machine according to one aspect is a rubbing determination program for a rotary machine, which includes a fixed part and a rotary part, causing a computer to execute a step of acquiring an AE signal detected by an AE sensor provided in the rotary machine, a step of acquiring a gap amount between the fixed part and the rotary part, a step of generating a rubbing determination evaluation index based on the AE signal and the gap amount, and a step of determining rubbing in the rotary machine based on the rubbing determination evaluation index.

According to the aspect of the above (12), rubbing determination is performed based on the rubbing determination evaluation index generated based on the AE signal detected by the AE sensor and on the gap amount that is the measured value or the estimated value. As a result, better determination accuracy can be obtained as compared with the rubbing determination based only on either the AE signal or the gap information.

### REFERENCE SIGNS LIST

1 rotary machine
2 stationary part
3 supply system
4 rotary part
4a rotor blade
5 discharge part
6a, 6b bearing
7a, 7b bearing box
10 sensor
13 gap sensor
100 rubbing determination device
102 signal acquisition unit
104 gap amount acquisition unit
106 rubbing determination evaluation index generation unit
108 rubbing determination unit
110 input layer
112 intermediate layer
114 output layer
120 first rubbing occurrence index calculation unit
122 second rubbing occurrence index calculation unit
124 rubbing determination evaluation index calculation unit

1. A rubbing determination device for a rotary machine, which includes a fixed part and a rotary part, the device comprising:
an AE signal acquisition unit for acquiring an AE signal detected by an AE sensor provided in the rotary machine;
a gap amount acquisition unit for acquiring a gap amount between the fixed part and the rotary part;
a rubbing determination evaluation index generation unit for generating a rubbing determination evaluation index based on the AE signal and the gap amount; and
a rubbing determination unit for determining rubbing in the rotary machine based on the rubbing determination evaluation index.

2. The rubbing determination device for a rotary machine according to claim 1, wherein the rubbing determination evaluation index generation unit calculates, as the rubbing determination evaluation index, a combination index of the AE signal and the gap amount.

3. The rubbing determination device for a rotary machine according to claim 2,
wherein the rubbing determination evaluation index generation unit includes
a first rubbing occurrence index calculation unit for calculating a first rubbing occurrence probability based on the AE signal,
a second rubbing occurrence index calculation unit for calculating a second rubbing occurrence probability based on the gap amount, and
a rubbing determination evaluation index calculation unit for calculating, as the combination index, rubbing occurrence probabilities corresponding to the first rubbing occurrence index calculated by the first rubbing occurrence index calculation unit and the second rubbing occurrence index calculated by the second rubbing occurrence index calculation unit by using a map that defines the rubbing occurrence probabilities for the first rubbing occurrence index and the second rubbing occurrence index.

4. The rubbing determination device for a rotary machine according to claim 2, wherein the rubbing determination evaluation index generation unit generates the rubbing determination evaluation index by correcting the gap amount based on the combination index.

5. The rubbing determination device for a rotary machine according to claim 4, wherein the rubbing determination evaluation index generation unit corrects the gap amount to become zero when the combination index reaches a preset threshold value.

6. The rubbing determination device for a rotary machine according to claim 1, wherein the gap amount is an estimated value calculated based on operation data of the rotary machine.

7. The rubbing determination device for a rotary machine according to claim 1,
wherein the gap amount is an estimated value calculated by inputting operation data of the rotary machine into a machine learning model, and
the machine learning model is modified by feeding back the rubbing determination evaluation index.

8. The rubbing determination device for a rotary machine according to claim 1, wherein the gap amount is an actually measured value detected by a gap sensor provided in the rotary machine.

9. The rubbing determination device for a rotary machine according to claim 1, wherein the AE signal is acquired by the AE sensor provided in a bearing portion that rotatably supports the rotary part with respect to a stationary part.

10. The rubbing determination device for a rotary machine according to claim 1, wherein the rotary machine is a steam turbine.

11. A rubbing determination method for a rotary machine, which includes a fixed part and a rotary part, the method comprising:
a step of acquiring an AE signal detected by an AE sensor provided in the rotary machine;
a step of acquiring a gap amount between the fixed part and the rotary part;
a step of generating a rubbing determination evaluation index based on the AE signal and the gap amount; and
a step of determining rubbing in the rotary machine based on the rubbing determination evaluation index.

12. A storage medium that stores a rubbing determination program for a rotary machine, which includes a fixed part and a rotary part, causing a computer to execute:
a step of acquiring an AE signal detected by an AE sensor provided in the rotary machine;
a step of acquiring a gap amount between the fixed part and the rotary part;
a step of generating a rubbing determination evaluation index based on the AE signal and the gap amount; and
a step of determining rubbing in the rotary machine based on the rubbing determination evaluation index.
